(19) United States
(12) Patent Application Publication
(10) Pub. No.: US 2018/0141093 A1
(43) Pub. Date: May 24, 2018

(54) Fume Hood with Windable Sash

(71) Applicants: David R. Hall, Provo, UT (US); Grant Getts, Provo, UT (US); Seth Myer, Eagle Mtn., UT (US)

(72) Inventors: David R. Hall, Provo, UT (US); Grant Getts, Provo, UT (US); Seth Myer, Eagle Mtn., UT (US)

(21) Appl. No.: 15/358,915

(22) Filed: Nov. 22, 2016

(51) Int. Cl. B08B 15/02

(52) U.S. Cl. CPC B08B 15/023; B08B 2215/006

(57) ABSTRACT

In various example embodiments, a fume hood apparatus is disclosed. The fume hood apparatus comprises an enclosure defining a workspace with a windable transparent sash at the face of the hood that is wound around a roller shaft when in a storage state. The apparatus further comprises an air filter assembly, sash position sensors, exhaust and supply air ducting with fans and dampers controlled by a microprocessor, along with a user interface that allows monitoring and control of the various functions of the apparatus.

### FIELD OF THE INVENTION

This invention generally relates to fume hoods and more specifically to the sash and air flow control.

### BACKGROUND OF THE INVENTION

Fume hoods are designed to provide protection to users in a workspace from hazardous or toxic fumes by ventilating contaminated air from the workspace and ventilating it outside of the workspace area. There are open systems that vent the contaminated air to outside of the building and closed systems that filter the air and recirculate the clean air back into the building.

Most fume hood systems incorporate a sash at the face of the fume hood which provides a protective barrier between the user and the processes being carried out that produce noxious gases. The sash is normally transparent so that the user can see what they are doing, while protecting the user's face from the potentially harmful gases and other materials resulting from the work being done within the fume hood enclosure.

Fume hood systems also normally have a variety of different methods of monitoring the air quality, adjusting the airflow in and airflow out of the system, along with measuring and controlling the face velocity. Since the open area created by the sash opening can change as it is completely open, partially open or mostly closed, there are many fume hood systems that are designed to modify the air flow of the exhaust and supply air into the enclosure in order to keep a constant and safe face velocity.

Typical sashes are rigid and require frameworks, counterbalance systems, or other mechanical devices that facilitate the opening and closing of the sash. When a rigid sash is in the open position, it is difficult to store it when it is fully open. In order to avoid blocking the supply air intake, the open sash must be stored in an alternate location that does not block the intake. Some systems have a sectional sash with multiple rigid sections or panels similar to a garage door that allow the sash to be stored more effectively when in the open position. Some fume hoods have a very high ceiling allowing space for the sash to be lifted directly up when opened. In every case, the design of the system must account for the sash when it is in the open or stored position.

What is needed is a fume hood system that utilizes a sash that can be stored easily and in a compact space not interfering with other system components. A fume hood of this type could be installed in a location where there is less available space or room for the fume hood, allowing either more fume hoods within a given space or locating it in a small room.

It is also important for the fume hood system to be capable of adjusting the air flow in and out of the enclosure based on the sash height to accomplish the required face velocity. The fume hood system also should have multiple sashes as needed to isolate areas within the enclosure that must be protected from the noxious environment within the enclosure. The opening and closing of the sashes should be done manually or by an electric motor controlled by an integrated control system. It is also desirable for the system to allow monitoring and control of the various conditions within the enclosure, comprising temperature; pressure; air flow including face velocity and sidewall velocity; air quality before and after filtering; including all required sensors and control systems, along with visual and audible alerts to maintain a safe environment for the user.

### SUMMARY

This invention has been developed in response to the present state of the art and, in particular, in response to the problems and needs in the art that have not yet been fully solved by currently available systems and methods. Features and advantages of different embodiments of the invention will become more fully apparent from the following description and appended claims, or may be learned by practice of the invention as set forth hereinafter.

Consistent with the foregoing, a fume hood apparatus is disclosed. The fume hood apparatus comprises an enclosure defining a workspace with a windable transparent sash at the face of the hood that is wound around a roller shaft when in a storage state. When the sash is closed, the sash is unrolled from the roller sash and brought down in front of the face of the fume hood.

An air filter assembly is located above the workspace feeding into an exhaust duct with a regulating mechanism disposed above the workspace for regulating exhaust air flowing from the fume hood through the exhaust duct. There is also an auxiliary air supply regulating mechanism disposed above the workspace for regulating air ambient supply input;

The sash frame includes sash position sensors measuring the position of the sash, and the sensors communicate the sash position to a microprocessor which in turn sends a signal to one of several controllers that control dampers, fan motors and other system devices as required to ventilate the air and regulate the operation of all the system devices and components. This includes a face velocity measuring device capable of outputting a signal corresponding to a measured value of face velocity.

A microprocessor is included which is in communication with the face velocity measuring device, the sash position sensors, the auxiliary air supply regulating mechanism, and the exhaust regulating mechanism, the microprocessor containing data representing an air flow response characteristic of the air flow regulating mechanism. A controller is included for controlling the exhaust regulating mechanism and auxiliary air supply regulating mechanism in response to the signal outputted from the face velocity measuring device, the sash position sensors, a face velocity setpoint, and an air flow response characteristic of the exhaust regulating mechanism. The control of the air flows into the workspace and exhausting out of the enclosure are adjusted according to the sash height as communicated to the microprocessor which in turn is relayed to the controller. The extent to which the sashes cover said opening periodically over a period of time is monitored; and the rate of air flow is adjusted to maintain a preselected average face velocity.

Regulating mechanisms include an exhaust regulating mechanism which comprises an exhaust damper, the damper position controlled by the controller; and an exhaust fan, the fan speed controlled by the controller. There is also an auxiliary air supply regulating mechanism which comprises a supply fan, the fan speed controlled by the controller; and a supply damper, the damper position controlled by the controller. The exhaust damper and supply damper each has a nonlinear response of flow rate to damper position.

The apparatus further includes a face velocity measuring device, which is positioned at approximately the face of the fume hood. The face velocity measuring device comprises a pitot or other known air flow sensor types. The face velocity measuring device measures air pressure at the face of the fume hood and the microprocessor further includes means for converting pressure measurement of the pitot into face velocity. Sidewall sensors measure air velocity along sidewalls of the enclosure and report this data to the microprocessor. The microprocessor in communication with the sidewall sensors, the face velocity measuring device, the sash position sensors, the exhaust regulating mechanism and auxiliary air supply regulating mechanism, the microprocessor containing data representing an air flow response characteristic of the exhaust regulating mechanism.

A controller in communication with the microprocessor, controls the exhaust regulating mechanism and auxiliary air supply regulating mechanism in response to the signal outputted from the face velocity measuring device, the sidewall sensors, the sash position sensors, a face velocity setpoint, and an air flow response characteristic of the exhaust regulating mechanism.

Gas detectors sensing the presence and concentrations of gas fumes are included, wherein this data is communicated to the microprocessor. The controller adjusts the air flow based on fume type and concentration and preset minimum levels, increasing the air flow to maintain a level of air flow as required to meet these minimum levels. Visual and audible alerts communicate gas types and concentration levels to a user or users. The gas detectors are of one or more type comprising: semiconductors; oxidation; catalytic; photoionization; infrared point; infrared imaging; electrochemical; catalytic bead; ultrasonic; metal oxide, acid array and holographic.

In addition to the main sash at the face of the enclosure, additional sashes cover an area or areas within the enclosure, separating these areas from the main workspace within the enclosure. These sashes are wound and unwound onto the roller shaft by an electric motor, the motor controlled by a user operated switch or the controller.

A touchscreen display monitor is included for facilitating communication and control between microprocessor and a user.

The exhaust air and auxiliary air flows are controlled by devices within exhaust and auxiliary ducting by the controller as directed by the microprocessor containing data representing air flow response characteristics. The devices comprise venture valves; VAV boxes; blade and frame dampers; pressure based flow stations; and thermal based flow stations. Pressure and temperature sensors are also included, communicating to the microprocessor.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is an isometric view of the fume hood apparatus, according to one example embodiment.

FIG. 2A shows the fume hood with the sash in a closed position according to one example embodiment.

FIG. 2B shows the fume hood with the sash in a partially open position, according to another example embodiment.

FIG. 3A is a side view of the fume hood with the sash mostly closed and shows the air flow through the fume hood enclosure according to one example embodiment.

FIG. 3B is a side view of the fume hood with the sash completely open and shows the air flow through the fume hood enclosure according to another example embodiment.

FIG. 4 is an isometric view of the fume hood enclosure showing the sidewalls, according to one example embodiment.

FIG. 5 is an isometric view of the fume hood apparatus with two sashes, according to one example embodiment.

FIG. 6A is a side view of the fume hood enclosure showing two sashes and adjacent container section, according to one example embodiment.

FIG. 6B is an overhead view of the fume hood enclosure showing two sashes and adjacent containers, according to one example embodiment.

FIG. 7 is a side view of the fume hood with the sash partially open and shows devices from connected systems in the supply and exhaust duct lines, according to one example embodiment.

FIG. 8A is an isometric view of the flexible sash showing the side channels on either side of the sash, according to one example embodiment.

FIG. 8B is an isometric view of the flexible sash showing the side channels on either side of the sash with a motor at the top, according to one example embodiment.

FIG. 9 is a detail of the side channel including the sash position sensor, according to one example embodiment.

### DETAILED DESCRIPTION OF THE DRAWINGS

The description that follows includes various apparatus, systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various embodiments, an apparatus as described herein comprises a fume hood with an enclosure defining a workspace, a windable transparent sash, a roller shaft wherein the sash is wound around the shaft. Other embodiments further comprise an air filter assembly, exhaust and auxiliary supply ducts with dampers and fans, sensors, motors, user interface display, controllers and a microprocessor.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “component,” or “system.” Furthermore, aspects of the present invention may take the form of a computer program product embodied in one or more computer readable medium(s) having program code embodied thereon.

Many of the functional units described in this specification have been labeled as components, in order to more particularly emphasize their implementation independence.

For example, a component may be implemented as a hardware circuit comprising custom VLSI circuits or gate arrays, off-the-shelf semiconductors such as logic chips, transistors, or other discrete components. A component may also be implemented in programmable hardware devices such as field programmable gate arrays, programmable array logic, programmable logic devices or the like.

Furthermore, the described features, structures, or characteristics of the embodiments may be combined in any suitable manner. In the following description, numerous specific details are provided, such as examples of communication between various system devices, components, controllers, microprocessors, user selections, network transactions, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

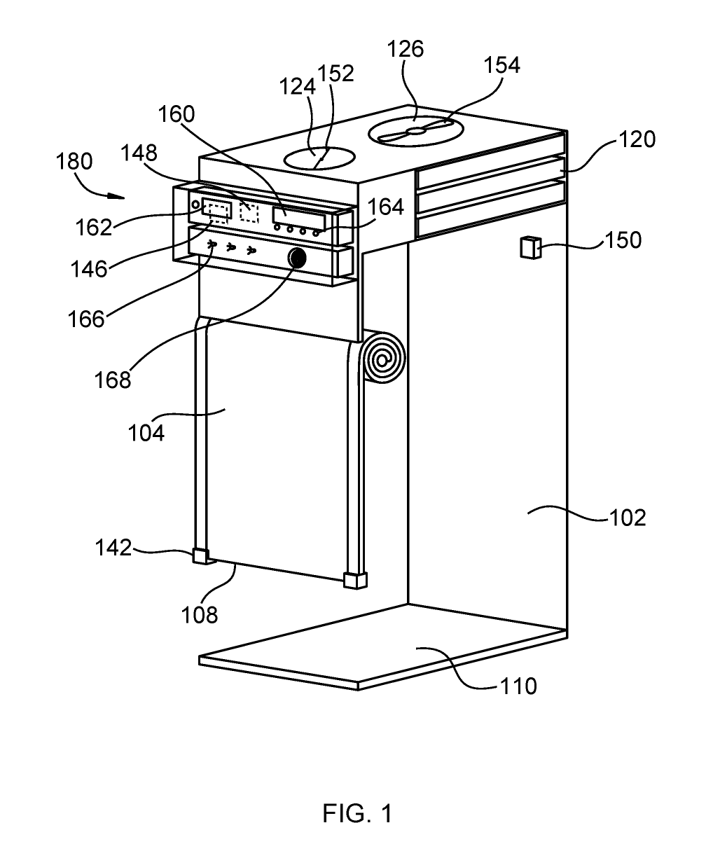

FIG. 1 is an isometric view of the fume hood apparatus. The enclosure consists of three walls surrounding a workspace. Only the back wall is shown for clarity, the two sidewalls are not shown. The front face of the enclosure 102 has an opening for the windable transparent sash 104. The top of the enclosure has an air filter assembly 120 with an exhaust air output 126 and an auxiliary air supply input 124. The windable transparent sash 104 is wound around the roller shaft 106. The sash 104 is shown in a partially unwound state or position 108.

At the top of the enclosure is the air filter assembly 120. Fresh air ambient is drawn into the enclosure from the auxiliary air supply input 124, drawn through the filter assembly, then exhausted through the exhaust air output 126.

The normal operation of the system includes opening the sash to set up the work to be carried out at the workspace 110. When the sash is opened, the sash position sensors 142 inform the microprocessor 146 regarding sash position, and the controller 148 adjusts the air flow through the fume hood via the exhaust regulating mechanism 154 and the air supply regulating mechanism 152 based on preset standards for the open area in order to maintain minimum safe face velocity. Gas detectors 150 are mounted near the top of the enclosure.

The monitoring and control of the system is carried out at the main user interface panel 180, which comprises a touchscreen display 160, visual display screen 162, user input devices 164 such as pushbuttons, dials and tuners, LED indicator lights 166 and speakers 168 for audible alerts.

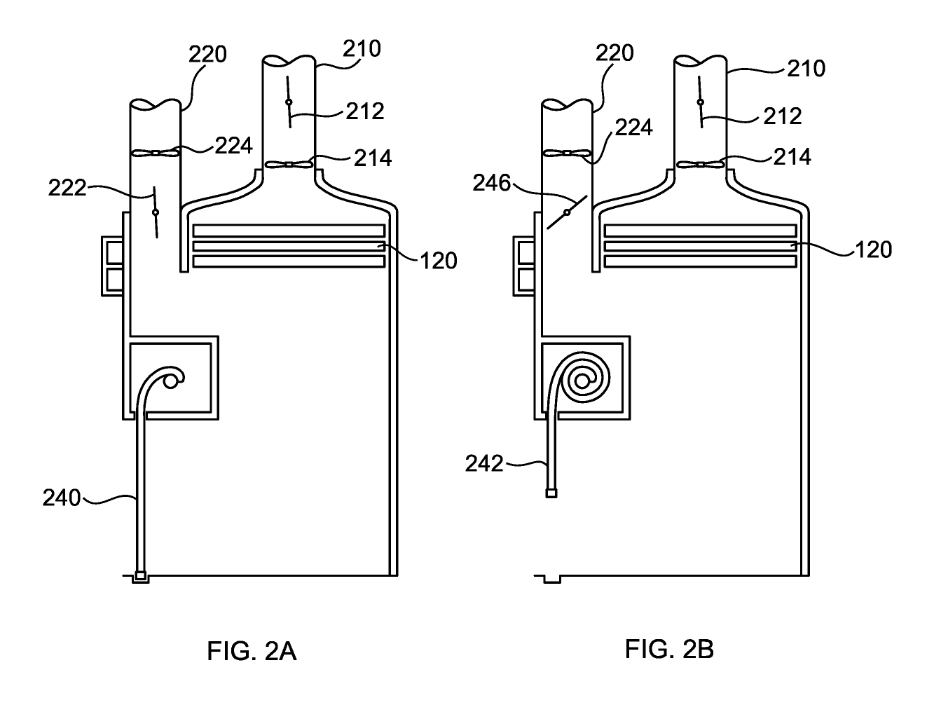

FIG. 2A shows the fume hood with the sash in a closed position 240. In cases where the space within the enclosure still needs to be ventilated, even with the sash closed, air is allowed to enter the enclosure via the auxiliary air supply duct 220. The auxiliary air supply damper 222 is in a fully open position. The auxiliary air supply fan 224 is shown in the supply duct 220 and can assist in enhancing the air flow. The exhaust fan 214 is above the air filter assembly 120, drawing the air across the filters and out the exhaust duct 210. The exhaust damper 212 is shown fully open.

FIG. 2B shows the fume hood with the sash in a partially open position 242. When the sash is open, less supply air is needed so the auxiliary air supply damper is partially closed 246, allowing more air to enter below the open sash. The auxiliary air supply fan 224 is shown in the supply duct 220 and can assist in enhancing the air flow. The exhaust fan 214 is above the air filter assembly 120, drawing the air across the filters and out the exhaust duct 210. The exhaust damper 212 is shown fully open.

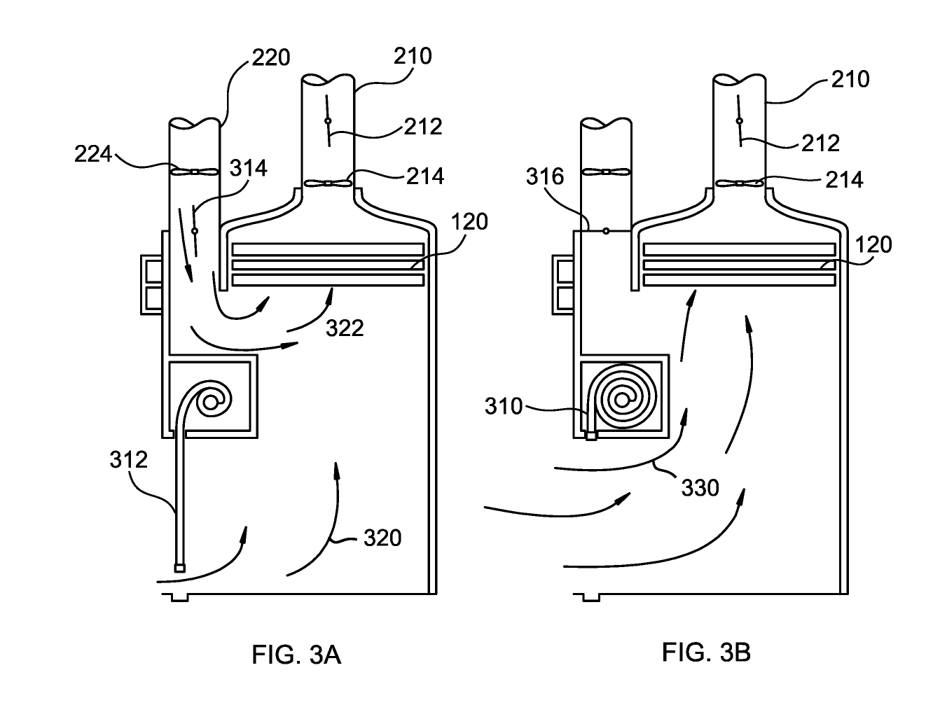

FIG. 3A is a side view of the fume hood with the sash mostly closed and shows the air flow through the fume hood enclosure. The sash is in a mostly closed position 312, allowing a minimal amount of air flow 320 under the sash opening. In order to allow enough airflow to proper ventilate the hood enclosure, additional supply air 322 is drawn from the auxiliary air supply duct 220. Supply fan 224 and fully open supply damper 314 assist in bringing supply air into the enclosure. Auxiliary supply air 322 is then drawn up through the air filter assembly 120 by the exhaust fan 214, through the exhaust damper 212 in a fully open position and out the exhaust duct 210.

FIG. 3B is a side view of the fume hood with the sash completely open and shows the air flow through the fume hood enclosure. The sash is in a fully open position 310, allowing adequate air flow 330 under the sash opening. In this embodiment, additional air is not required, so the auxiliary air damper is in a closed position 316. Air 330 is then drawn up through the air filter assembly 120 by the exhaust fan 214, through the exhaust damper 212 in a fully open position and out the exhaust ducting 210.

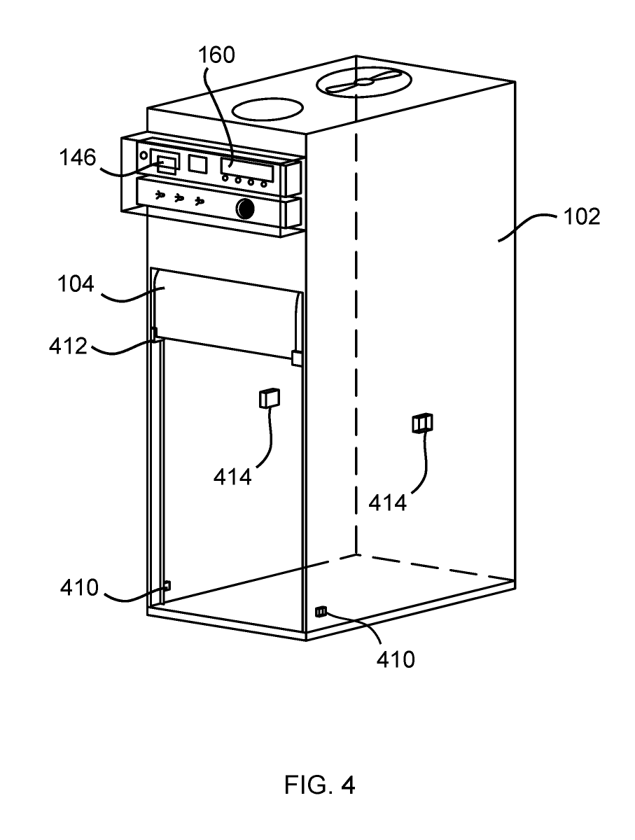

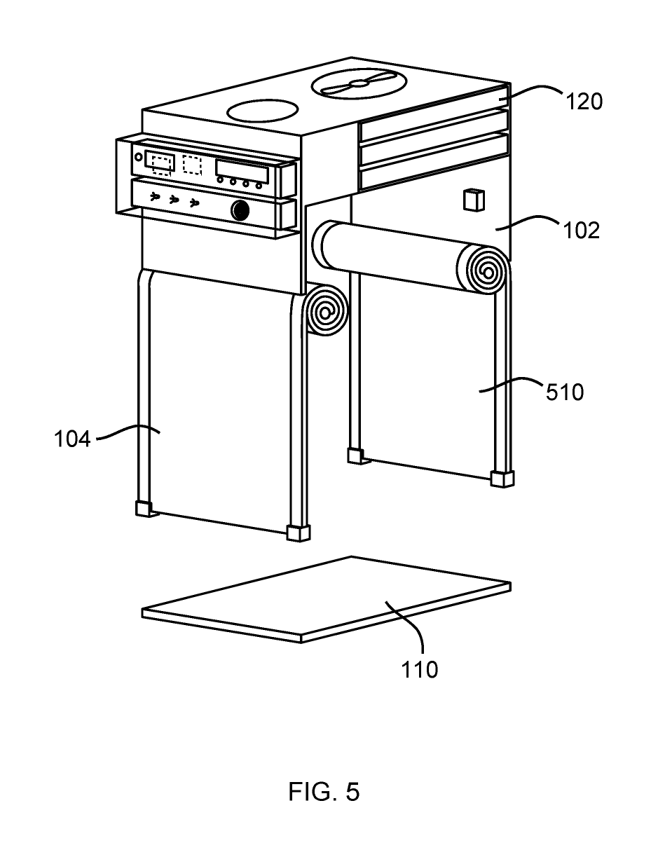

FIG. 4 is an isometric view of the fume hood enclosure 102 showing the sidewalls. The sash 104 is shown at the front face of the enclosure in a mostly open position. Sash position sensors 412 detect the sash position and communicate the position to the microprocessor 146. The airflow is measured by the face velocity measuring device 410, along with the sidewall sensors 414, and adjustments to the regulating mechanisms are further adjusted as necessary to maintain the appropriate air flow. A touchscreen display 160 is provided for a user interface to allow monitoring and control of the system.

FIG. 5 is an isometric view of the fume hood apparatus with two sashes. The enclosure consists of two walls surrounding a workspace. The two side walls are not shown for clarity. The front face of the enclosure 102 has an opening for the windable transparent sash 104 and the back wall is also open with a second sash 510 that is capable of closing off the back side of the enclosure. The top of the enclosure has an air filter assembly 120 above, a workspace 110 below and other components as detailed in the other figures.

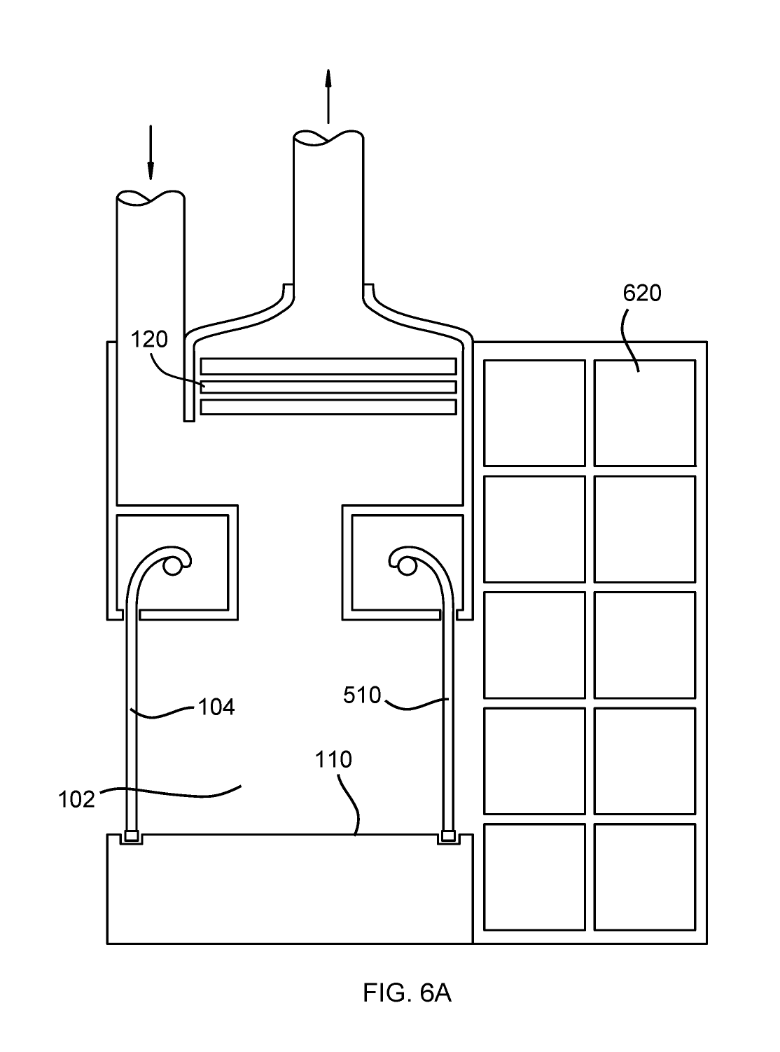

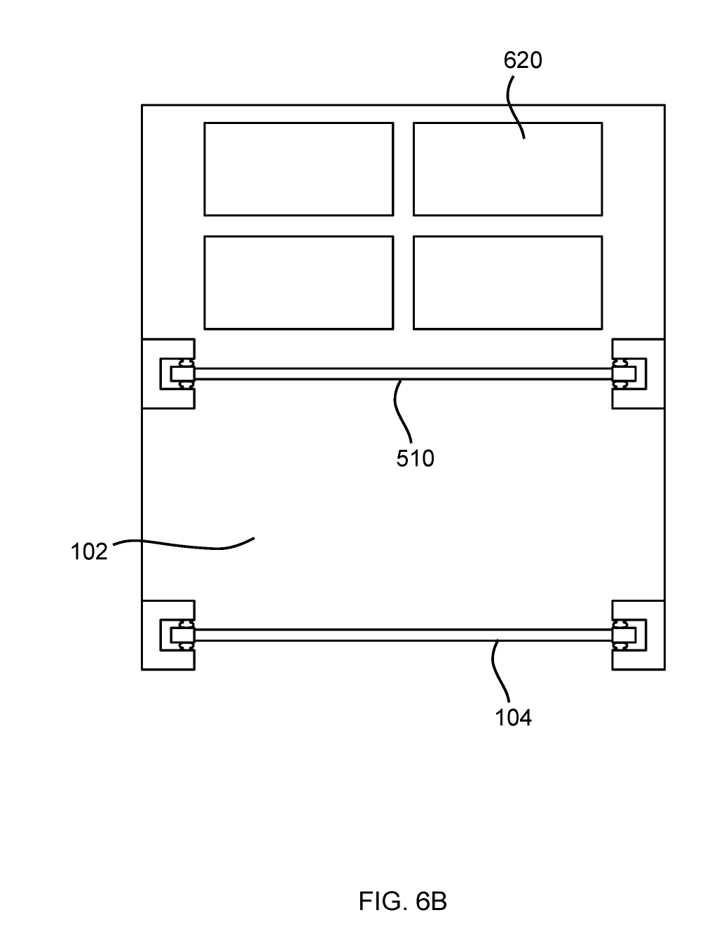

FIG. 6A is a side view of the fume hood enclosure showing containers 620 that must be isolated from the workspace area during a work session. The front face of the enclosure 102 has an opening for the windable transparent sash 104. The second sash 510 separates the containers 620 from the active enclosure 102 area. The top of the enclosure has an air filter assembly 120 above, a workspace 110 below and other components as detailed in the other figures. The containers 620 may contain food products or other components that must be protected from the noxious gases within the enclosure 102. The second sash 510 allows access to these components when the air has been cleared from the hazardous or noxious gases. The second sash 510 may be transparent or opaque.

FIG. 6B is an overhead view of the fume hood enclosure showing containers 620 that must be isolated from the workspace area during a work session. The front face of the enclosure 102 has an opening for the windable transparent sash 104. The second sash 510 separates the containers 620 from the active enclosure 102 area.

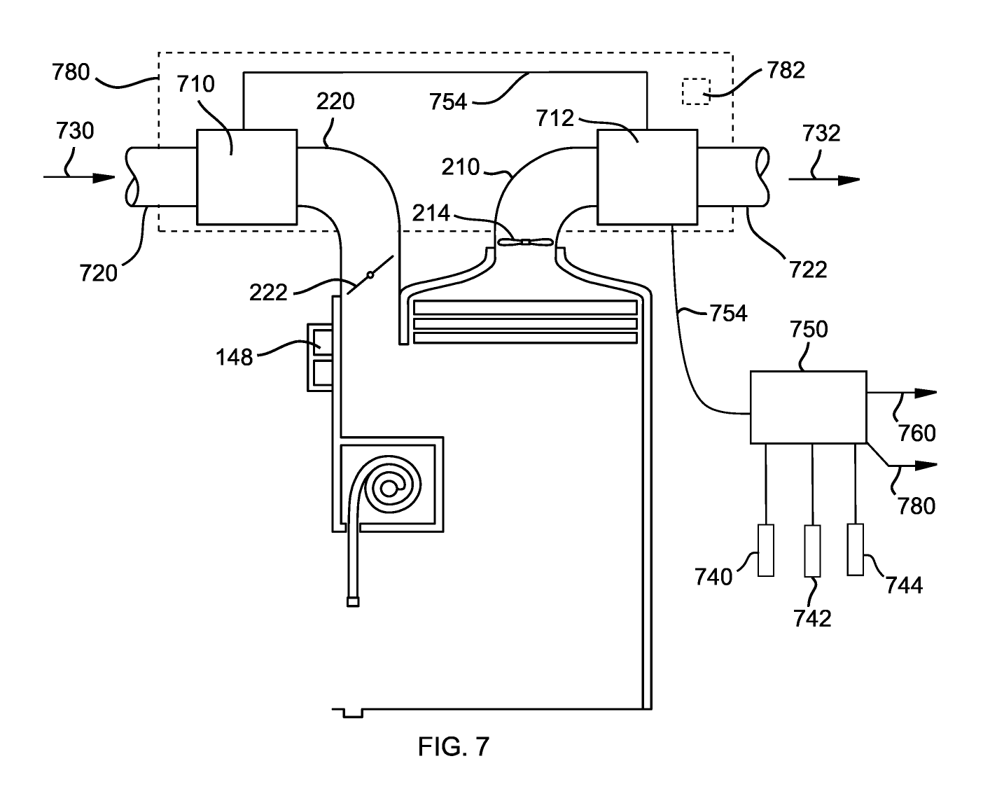

FIG. 7 is a side view of the fume hood with the sash partially open and shows devices from connected systems in the supply and exhaust duct lines. In this embodiment, the fume hood apparatus is integrated into an air handling system 780. Supply air control devices 710, and exhaust air control devices 712 must be coordinated with the fume hood system. The control of these devices is either under direct control from the fume hood controller 148 via a fume hood network control line 760, or via an air handler network control line interface 780 from the air handler controller 782 to the fume hood controller 148. The air flow into the fume hood system 730, and the exhaust air out of the fume hood system 732 must be controlled in order to maintain the required face velocity air flow within the fume hood. The fume hood supply duct 220 is connected to the air handler device 710, and air handler supply air duct 720 extends to the air handler system 780. The fume hood exhaust duct 210 is connected to the exhaust air control device 712, which is connected to an air handler exhaust duct 722. The control of fume hood control devices such as exhaust fan 214 and supply air damper 222 is coordinated with the air handler system to assure that required air flows are maintained.

The exhaust air control devices 712 and supply air control devices 710 comprising venturi valves; VAV boxes; blade and frame dampers; pressure based flow stations; and thermal based flow stations. Additional sensors such as temperature 740, pressure 742 and air flow velocity 744 are integrated via control equipment 750 as required to enable the apparatus to be compatible with the connected devices and systems while maintaining the required functionality of the fume hood apparatus. Network lines 754 connect the control equipment 750 to control devices 710 and 712. Network line 780 extends to the air handler controller and network line 760 extends to the fume hood controller.

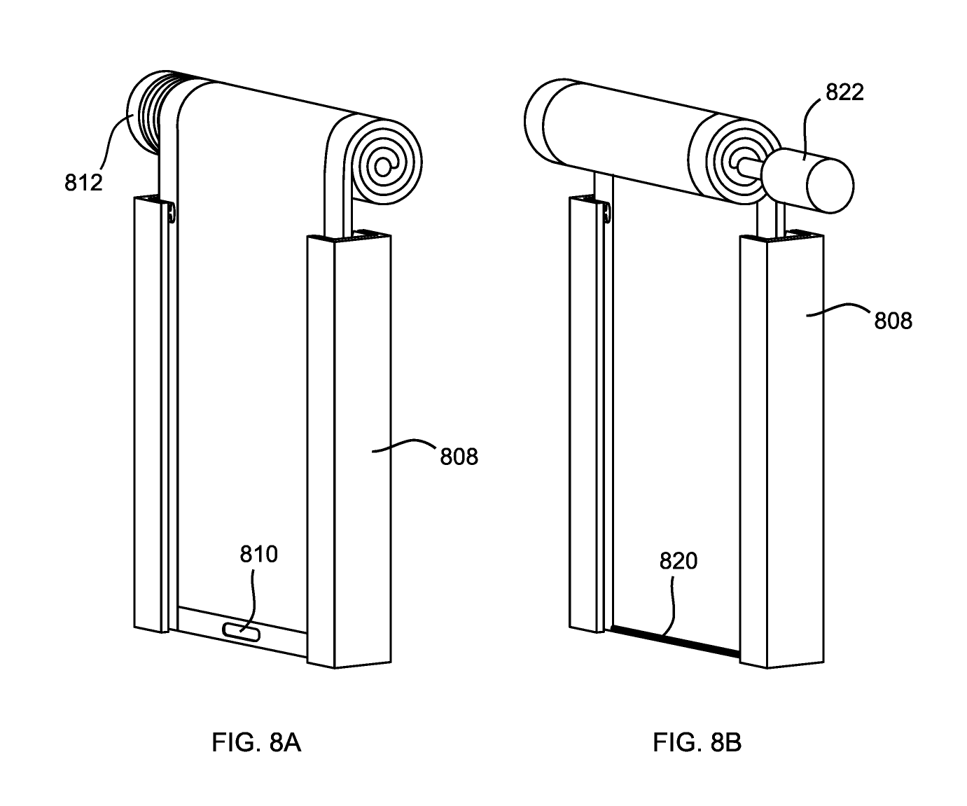

FIG. 8A is an isometric view of the flexible sash showing the side channels on either side of the sash. The side channel 808 provides a channel or track in order to seal the sides of the sash 104, preventing any airflow on the sides of the sash 104. A counterbalanced coiled spring 812 is mounted at the top of the sash to provide assistance in manually opening the sash by a user. The user operates the sash by lifting or pulling down the sash at handhole 810. The handhole may also comprise a handle or other gripping device that allows the user to move the sash up or down.

FIG. 8B is an isometric view of the flexible sash showing the side channels on either side of the sash with a motor at the top. The side channel 808 provides a channel or track in order to seal the sides of the sash 104, preventing any airflow on the sides of the sash 104. An electric motor 822 is mounted at the top of the sash that opens and closes the sash. The motor is controlled by the controller as directed by the microprocessor and the programming specific to when the sash is to be opened and closed, and how much it is to be opened or closed. A specific opening area can be achieved by the control system as required. The motor may also be controlled by the user via a control switch. A weighted bar 820 at the bottom of the sash provides stabilization of the sash when opening or closing.

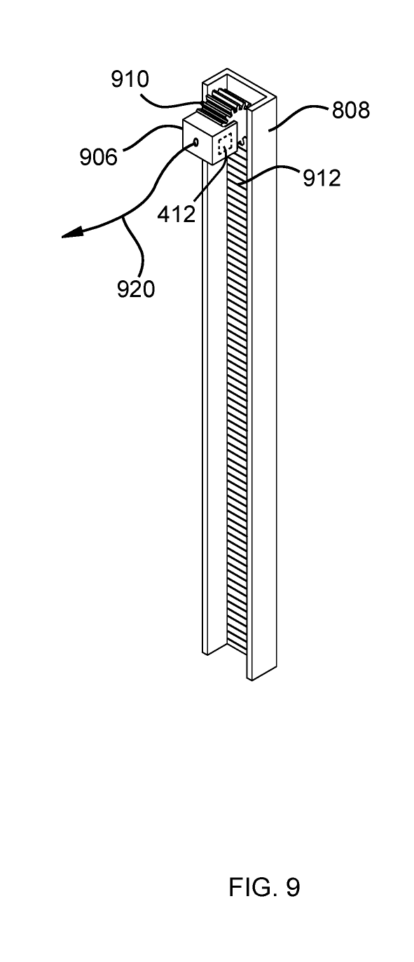

FIG. 9 is a detail of the side channel 808 including the sash position sensor 412. A gear or tracking wheel 910 travels along the channel 808, interfacing into slots 912 as it tracks up or down the channel 808 as the sash is opening or closing. The tracking wheel 910 communicates the position to the sash position sensor 412 which communicates the sash position to the microprocessor via network control line 920. The sensor is mounted within the sash frame assembly 906.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A fume hood apparatus comprising:
an enclosure defining a workspace and an access opening;
a windable transparent sash;
a roller shaft which rotates about a main axis connected to the sash; and
wherein the sash is wound around the roller shaft in a storage state and is at least partially
unwound from the roller shaft in an operating state of the fume hood.

2. The apparatus of claim 1 further comprising:
an air filter assembly located above the workspace;
an auxiliary air supply duct;
an exhaust duct with a regulating mechanism disposed above the workspace for regulating exhaust air flowing from the fume hood through the exhaust duct;
an auxiliary air supply regulating mechanism disposed above the workspace for regulating air ambient supply input;
sash position sensors measuring the position of the sash, capable of outputting a signal corresponding to sash position;
a face velocity measuring device capable of outputting a signal corresponding to a measured value of face velocity;
a microprocessor in communication with the face velocity measuring device, the sash position sensors, the auxiliary air supply regulating mechanism, and the exhaust regulating mechanism, the microprocessor containing data representing an air flow response characteristic of the exhaust regulating mechanism; and
a controller for controlling the exhaust regulating mechanism and auxiliary air supply regulating mechanism in response to the signal outputted from the face velocity measuring device, the sash position sensors, a face velocity setpoint, and an air flow response characteristic of the exhaust regulating mechanism.

3. The apparatus of claim 2, wherein the exhaust regulating mechanism comprises:
an exhaust damper, the damper position controlled by the controller; and
an exhaust fan, the fan speed controlled by the controller.

4. The apparatus of claim 2, wherein the auxiliary air supply regulating mechanism comprises:
a supply fan, the fan speed controlled by the controller; and
a supply damper, the damper position controlled by the controller.

5. The apparatus of claim 3, wherein the exhaust damper has a nonlinear response of flow rate to damper position.

6. The apparatus of claim 4, wherein the supply damper has a nonlinear response of flow rate to damper position.

7. The apparatus of claim 2, wherein the face velocity measuring device is positioned at approximately the face of the fume hood.

8. The apparatus of claim 5, wherein the face velocity measuring device comprises a pitot.

9. The apparatus of claim 6, wherein the pitot measures air pressure at the face of the fume hood and the microprocessor further includes means for converting pressure measurement of the pitot into face velocity.

10. The apparatus of claim 2, further comprising sidewall sensors measuring air velocity along sidewalls of the enclosure and reporting this data to the microprocessor;
the microprocessor in communication with the sidewall sensors, the face velocity measuring device, the sash position sensors, the exhaust regulating mechanism and auxiliary air supply regulating mechanism, the microprocessor containing data representing an air flow response characteristic of the exhaust regulating mechanism; and
a controller in communication with the microprocessor for controlling the exhaust regulating mechanism and auxiliary air supply regulating mechanism in response to the signal outputted from the face velocity measuring device, the sidewall sensors, the sash position sensors, a face velocity setpoint, and an air flow response characteristic of the exhaust regulating mechanism.

11. The apparatus of claim 2, further comprising gas detectors sensing the presence and concentrations of gas fumes, wherein this data is communicated to the microprocessor.

12. The apparatus of claim 11, wherein the controller adjusts the air flow based on fume type and concentration and preset minimum levels, increasing the air flow to maintain a level of air flow as required to meet these minimum levels.

13. The apparatus of claim 11, further comprising visual and audible alerts communicating gas types and concentration levels to a user or users.

14. The apparatus of claim 11, wherein the gas detectors are of one or more type comprising: semiconductors; oxidation; catalytic; photoionization; infrared point; infrared imaging; electrochemical; catalytic bead; ultrasonic; metal oxide, acid array and holographic.

15. The apparatus of claim 1, further comprising two or more sashes covering two or more openings.

16. The apparatus of claim 15, wherein one or more of the two or more sashes cover an area within the enclosure, separating the area from the remainder of the space within the enclosure.

17. The apparatus of claim 15, wherein one or more of the two or more sashes are flexible and windable, transparent or opaque, wound or unwound onto the roller shaft by an electric motor; the motor controlled by a user operated switch or the controller.

18. The apparatus of claim 2, further comprising a touchscreen display monitor for facilitating communication and control between microprocessor and a user.

19. The apparatus of claim 2, wherein the exhaust duct and auxiliary supply air duct are connected and extended to external devices or air handling systems;
Wherein the microprocessor interfaces with the control system of the external devices or air handling systems;
the devices comprising venturi valves; VAV boxes; blade and frame dampers; pressure based flow stations; and thermal based flow stations.
the apparatus further comprising additional sensors and control equipment as required to enable the apparatus to be compatible with the connected devices and systems while maintaining the required functionality of the fume hood apparatus.

20. The apparatus of claim 15, further comprising: monitoring the extent to which the sashes cover the openings periodically over a period of time; and adjusting the rate of air flow to maintain a preselected average face velocity.
